(19) United States
(12) Patent Application Publication
(10) Pub. No.: US 2022/0220891 A1
(43) Pub. Date: Jul. 14, 2022

(54) COMBINED CYCLE POWER DEVICE

(71) Applicant: Huayu Li, Qindao, Shandong (CN)

(72) Inventor: Huayu Li, Qindao, Shandong (CN)

(21) Appl. No.: 17/609,316

(22) PCT Filed: Apr. 28, 2020
(86) PCT No.: PCT/CN2020/000094

§ 371 Date: Nov. 5, 2021

(30) Foreign Application Priority Data
May 6, 2019 (CN) 201910405144.8

(51) Int. Cl. F02C 1/00; F02C 6/00; F02C 7/36

(52) U.S. Cl. CPC F02C 1/00; F02C 7/36; F02C 6/003

(57) ABSTRACT

The combined cycle power device is provided in the present invention and belongs to the field of energy and power technology. A combined cycle power device comprising an expander, the second expander, a compressor, a pump, a high-temperature heat exchanger, a condenser and an evaporator. An evaporator connects the second expander after that a condenser passes through a pump and connects the evaporator. The second expander connects the high-temperature heat exchanger. A compressor connects the high-temperature heat exchanger. The high-temperature heat exchanger connects an expander. The evaporator connects the compressor and the condenser respectively after that the expander connects the evaporator. The high-temperature heat exchanger connects the outside. The condenser connects the outside. The evaporator connected the outside. The expander and the second expander connect the compressor and transmit power.

### FIELD

The present invention belongs to the flied of energy and power technology.

### BACKGROUND

Cold demand, heat demand and power demand are common in human life and production. It is an important way to obtain and provide power by the conversion of thermal energy into mechanical energy. In general, the temperature of heat source reduces and varies with the release of heat. When fossil fuels are used as the primary energy, the heat source has the dual characteristics of both high-temperature and variable temperature. This makes it is difficult to transform more heat energy into mechanical energy using the power device based on a single thermal cycle. For high-quality fuel, the traditional gas-steam combined cycle can be used to obtain a high thermal efficiency. However, there are still some problems to be solved, such as high cost, large investment and low thermal efficiency to be improved.

Take the vapor power device with the outside combustion for example, its heat source has the dual characteristics of high-temperature and variable temperature. For those vapor power devices based on the Rankine cycle, the material's temperature resistance and pressure resistance abilities and safety concerns limit the parameters of the cycle's working medium. Therefore, there is a big temperature difference between the working medium and the heat source, which leads to big irreversible loss and low efficiency. This means that there is great potential to improve the thermal efficiency.

Humans need to use heat energy simply, actively, efficiently for achieving power. Therefore, the present invention provides a combined cycle power device with high thermal efficiency, strong safety, adaptation to high-temperature heat source or variable temperature heat source and response to various fuels.

### THE CONTENTS OF THE PRESENT INVENTION

The combined cycle power device are mainly provided in the present invention, and the specific contents of the present invention are as follows:

1. A combined cycle power device comprising an expander, the second expander, a compressor, a pump, a high-temperature heat exchanger, a condenser and an evaporator. An evaporator has a vapor channel connected the second expander after that a condenser has a liquid refrigerant pipe which passes through a pump and connects the evaporator, the second expander has a vapor channel connected the high-temperature heat exchanger, a compressor has a vapor channel connected the high-temperature heat exchanger, the high-temperature heat exchanger has a vapor channel connected an expander, the evaporator has a low-pressure vapor channel connected the compressor and the condenser respectively after that the expander has a low-pressure vapor channel connected the evaporator. The high-temperature heat exchanger has the heat source medium channel connected the outside, the condenser has the cooling medium channel connected the outside. Or the evaporator has the heat source medium channel connected the outside, the expander and the second expander connect the compressor and transmit power. Or the expander and the second expander connect the compressor and the pump and transmit power.

2. A combined cycle power device comprising an expander, the second expander, a compressor, a pump, a high-temperature heat exchanger, a condenser, an evaporator and a high-temperature regenerator. An evaporator has a vapor channel connected the second expander after that a condenser has a liquid refrigerant pipe which passes through a pump and connects the evaporator, the second expander has a vapor channel which passes through the high-temperature regenerator and connects the high-temperature heat exchanger, a compressor has a vapor channel which passes through the high-temperature regenerator and connects the high-temperature heat exchanger, the high-temperature heat exchanger has a vapor channel connected an expander, the expander has a low-pressure vapor channel connected the high-temperature regenerator, the evaporator has a low-pressure vapor channel connected the compressor and the condenser respectively after that the high-temperature regenerator has a low-pressure vapor channel connected the evaporator. The high-temperature heat exchanger has the heat source medium channel connected the outside, the condenser has the cooling medium channel connected the outside. Or the evaporator has the heat source medium channel connected the outside, the expander and the second expander connect the compressor and transmit power. Or the expander and the second expander connect the compressor and the pump and transmit power.

3. A combined cycle power device comprising an expander, the second expander, a compressor, a pump, a high-temperature heat exchanger, a condenser, an evaporator and the third expander. An evaporator has a vapor channel connected the second expander after that a condenser has a liquid refrigerant pipe which passes through a pump and connects the evaporator, the second expander has a vapor channel connected the high-temperature heat exchanger, a compressor has a vapor channel connected the high-temperature heat exchanger, the high-temperature heat exchanger has an intermediate vapor channel connected the third expander, the third expander has a low-pressure vapor channel which passes through intermediate vapor channel and connects the evaporator, the high-temperature heat exchanger has a vapor channel connected an expander, the expander has a low-pressure vapor channel connected the evaporator, the evaporator has a low-pressure vapor channel connected the compressor and the condenser respectively. The high-temperature heat exchanger has the heat source medium channel connected the outside, the condenser has the cooling medium channel connected the outside. Or the evaporator has the heat source medium channel connected the outside, the expander, the second expander and the third expander connect the compressor and transmit power. Or the expander, the second expander and the third expander connect the compressor and the pump and transmit power.

4. A combined cycle power device comprising an expander, the second expander, a compressor, a pump, a high-temperature heat exchanger, a condenser, an evaporator and the second high-temperature heat exchanger. An evaporator has a vapor channel which passes though the second high-temperature heat exchanger and connects the second expander after that a condenser has a liquid refrigerant pipe which passes through a pump and connects the evaporator, the second expander has a vapor channel connected the high-temperature heat exchanger, a compressor has a vapor channel connected the high-temperature heat exchanger, the high-temperature heat exchanger has a vapor channel connected an expander, the expander has a low-pressure vapor channel connected the evaporator, the evaporator has a low-pressure vapor channel connected the compressor and the condenser respectively. The high-temperature heat exchanger and the second high-temperature heat exchanger have the heat source medium channel connected the outside, the condenser has the cooling medium channel connected the outside. Or the evaporator has the heat source medium channel connected the outside, the expander and the second expander connect the compressor and transmit power. Or the expander and the second expander connect the compressor and the pump and transmit power.

5. A combined cycle power device comprising an expander, the second expander, a compressor, a pump, a high-temperature heat exchanger, a condenser, an evaporator and a heating unit. An evaporator has a vapor channel connected the second expander after that a condenser has a liquid refrigerant pipe which passes through a pump and connects the evaporator, the second expander has a vapor channel connected the high-temperature heat exchanger, a compressor has a vapor channel connected the high-temperature heat exchanger, the high-temperature heat exchanger has a vapor channel connected an expander, the expander has a low-pressure vapor channel connected the heating unit, the heating unit has a low-pressure vapor channel connected the compressor and the condenser respectively. The high-temperature heat exchanger has the heat source medium channel connected the outside, the condenser has the cooling medium channel connected the outside. Or the evaporator has the heat source medium channel connected the outside, the heating unit has a channel to be heated connected the outside, the expander and the second expander connect the compressor and transmit power. Or the expander and the second expander connect the compressor and the pump and transmit power.

6. A combined cycle power device comprising an expander, the second expander, a compressor, a pump, a high-temperature heat exchanger, a condenser, an evaporator and a heating unit. An evaporator has a vapor channel connected the second expander after that a condenser has a liquid refrigerant pipe which passes through a pump and connects the evaporator, the second expander has a vapor channel connected the high-temperature heat exchanger, a compressor has a vapor channel connected the high-temperature heat exchanger, the high-temperature heat exchanger has a vapor channel connected an expander, the expander has a low-pressure vapor channel connected an evaporator, an evaporator has a low-pressure vapor channel connected the heating unit, the heating unit has a low-pressure vapor channel connected the compressor and the condenser respectively. The high-temperature heat exchanger has the heat source medium channel connected the outside, the condenser has the cooling medium channel connected the outside. Or the evaporator has the heat source medium channel connected the outside, the heating unit has a channel to be heated connected the outside, the expander and the second expander connect the compressor and transmit power. Or the expander and the second expander connect the compressor and the pump and transmit power.

7. A combined cycle power device comprising an expander, the second expander, a compressor, a pump, a high-temperature heat exchanger, a condenser, an evaporator, the second high-temperature heat exchanger and the second compressor. An evaporator has a vapor channel connected the second expander after that a condenser has a liquid refrigerant pipe which passes through a pump and connects the evaporator, the second expander has a vapor channel connected the high-temperature heat exchanger, a compressor has a vapor channel connected the high-temperature heat exchanger, the high-temperature heat exchanger has a vapor channel connected the second compressor, the second compressor has a vapor channel which passes though the second high-temperature heat exchanger and connects the expander, the expander has a low-pressure vapor channel connected the evaporator, the evaporator has a low-pressure vapor channel connected the compressor and the condenser respectively. The high-temperature heat exchanger and the second high-temperature heat exchanger have the heat source medium channel connected the outside, the condenser has the cooling medium channel connected the outside. Or the evaporator has the heat source medium channel connected the outside, the expander and the second expander connect the compressor, the second compressor and transmit power. Or the expander and the second expander connect the compressor, the pump, the second compressor and transmit power.

8. A combined cycle power device comprising an expander, the second expander, a compressor, a pump, a high-temperature heat exchanger, a condenser, an evaporator, the second high-temperature heat exchanger and the third expander. An evaporator has a vapor channel connected the second expander after that a condenser has a liquid refrigerant pipe which passes through a pump and connects the evaporator, the second expander has a vapor channel connected the high-temperature heat exchanger, a compressor has a vapor channel connected the high-temperature heat exchanger, the high-temperature heat exchanger has an intermediate vapor channel connected the third expander, the third expander has a low-pressure vapor channel which passes through the second high-temperature heat exchanger and connects an expander, the expander has a low-pressure vapor channel connected the evaporator, the evaporator has a low-pressure vapor channel connected the compressor and the condenser respectively. The high-temperature heat exchanger and the second high-temperature heat exchanger have the heat source medium channel connected the outside, the condenser has the cooling medium channel connected the outside. Or the evaporator has the heat source medium channel connected the outside, the expander, the second expander and the third expander connect the compressor and transmit power. Or the expander, the second expander and the third expander connect the compressor and the pump and transmit power.

9. A combined cycle power device comprising an expander, the second expander, a compressor, a pump, a high-temperature heat exchanger, a condenser, an evaporator, a high-temperature regenerator, the second high-temperature heat exchanger and the second compressor. An evaporator has a vapor channel connected the second expander after that a condenser has a liquid refrigerant pipe which passes through a pump and connects the evaporator, the second expander has a vapor channel which passes through the high-temperature regenerator and connects the high-temperature heat exchanger, a compressor has a vapor channel which passes through the high-temperature regenerator and connects the high-temperature heat exchanger, the high-temperature heat exchanger has a vapor channel connected the second compressor, the second compressor has a vapor channel which passes though the second high-temperature heat exchanger and connects the expander, the expander has a low-pressure vapor channel connected the high-temperature regenerator, the high-temperature regenerator has a low-pressure vapor channel connected the evaporator, the evaporator has a low-pressure vapor channel connected the compressor and the condenser respectively. The high-temperature heat exchanger and the second high-temperature heat exchanger have the heat source medium channel connected the outside, the condenser has the cooling medium channel connected the outside. Or the evaporator has the heat source medium channel connected the outside, the expander and the second expander connect the compressor, the second compressor and transmit power. Or the expander and the second expander connect the compressor, the pump, the second compressor and transmit power.

10. A combined cycle power device comprising an expander, the second expander, a compressor, a pump, a high-temperature heat exchanger, a condenser, an evaporator, a high-temperature regenerator, the third expander and the second high-temperature heat exchanger. An evaporator has a vapor channel connected the second expander after that a condenser has a liquid refrigerant pipe which passes through a pump and connects the evaporator, the second expander has a vapor channel which passes through the high-temperature regenerator and connects the high-temperature heat exchanger, a compressor has a vapor channel which passes through the high-temperature regenerator and connects the high-temperature heat exchanger, the high-temperature heat exchanger has a vapor channel connected the third expander, the third expander has a vapor channel which passes though the second high-temperature heat exchanger and connects the expander, the expander has a low-pressure vapor channel connected the high-temperature regenerator, the high-temperature regenerator has a low-pressure vapor channel connected the evaporator, the evaporator has a low-pressure vapor channel connected the compressor and the condenser respectively. The high-temperature heat exchanger and the second high-temperature heat exchanger have the heat source medium channel connected the outside, the condenser has the cooling medium channel connected the outside. Or the evaporator has the heat source medium channel connected the outside, the expander, the second expander and the third expander connect the compressor and transmit power. Or the expander, the second expander and the third expander connect the compressor and the pump and transmit power.

11. The device according to any one of claim 1-10, wherein adding the low-temperature regenerator and the second pump, adjusting that the condenser has a liquid refrigerant pipe which passes through a pump and connects the evaporator to that the condenser has a liquid refrigerant pipe which passes through a pump and connects a low-temperature regenerator, the compressor adds the vapor extraction channel connected the low-temperature regenerator, the low-temperature regenerator has a liquid refrigerant pipe which passes through the second pump and connects the evaporator, a combined cycle power device is formed.

### BRIEF DESCRIPTION OF THE FIGURES

FIG. 1 is a type 1 example general flow chart of a combined cycle power device provided in the present invention.

FIG. 2 is a type 2 example general flow chart of a combined cycle power device provided in the present invention.

FIG. 3 is a type 3 example general flow chart of a combined cycle power device provided in the present invention.

FIG. 4 is a type 4 example general flow chart of a combined cycle power device provided in the present invention.

FIG. 5 is a type 5 example general flow chart of a combined cycle power device provided in the present invention.

FIG. 6 is a type 6 example general flow chart of a combined cycle power device provided in the present invention.

FIG. 7 is a type 7 example general flow chart of a combined cycle power device provided in the present invention.

FIG. 8 is a type 8 example general flow chart of a combined cycle power device provided in the present invention.

FIG. 9 is a type 9 example general flow chart of a combined cycle power device provided in the present invention.

FIG. 10 is a type 10 example general flow chart of a combined cycle power device provided in the present invention.

FIG. 11 is a type 11 example general flow chart of a combined cycle power device provided in the present invention.

In the figures, 1-expander, 2-the second expander, 3-compressor, 4-circulating pump, 5-high temperature heat exchanger, 6-condenser, 7-evaporator (waste heat boiler), 8-high temperature regenerator, 9-the third expander, 10-the second high-temperature heat exchanger, 11-heating unit, 12-the second compressor, 13-low temperature regenerator, 14-the second pump.

### DETAILED DESCRIPTION

The first thing to note is that, when describing the cycle's structures and processes, the processes will not be repeatedly described if not necessary, and the obvious processes will not be described. The detailed description of the present invention is as follows:

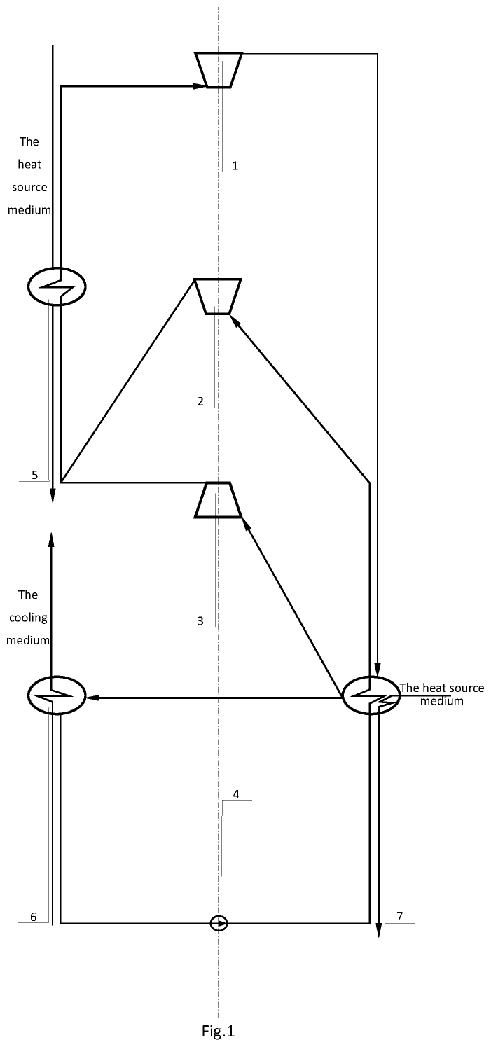

The combined cycle power device in FIG. 1 works as follows:

(1) Device structure. The combined cycle power device comprising an expander, the second expander, a compressor, a pump, a high-temperature heat exchanger, a condenser and an evaporator. An evaporator 7 has a vapor channel connected the second expander 2 after that a condenser 6 has a liquid refrigerant pipe which passes through a pump 4 and connects the evaporator 7, the second expander 2 has a vapor channel connected the high-temperature heat exchanger 5, a compressor 3 has a vapor channel connected the high-temperature heat exchanger 5, the high-temperature heat exchanger 5 has a vapor channel connected an expander 1, the evaporator 7 has a low-pressure vapor channel connected the compressor 3 and the condenser 6 respectively after that the expander 1 has a low-pressure vapor channel connected the evaporator 7. The high-temperature heat exchanger 5 has the heat source medium channel connected the outside, the condenser 6 has the cooling medium channel connected the outside. The evaporator 7 has the heat source medium channel connected the outside. The expander 1 and the second expander 2 connect the compressor 3 and transmit power.

(2) Working processes. The condensate of the condenser 6 flows through the pump 4 and enters into the evaporator 7 in which it absorbs heat, vaporizes and superheats, flows through the second expander 2 to depressurize and output work, and then enters the high-temperature heat exchanger 5 for heat absorption. The vapor discharged from compressor 3 enters the high-temperature heat exchanger 5 for heat absorption. The vapor discharged from the high-temperature heat exchanger 5 flows through the expander 1 to depressurize and output work. The low-pressure vapor discharged from the expander 1 flows through the evaporator 7 to release heat and cool down, and then is divided into two currents. The first current enters the compressor 3 for pressure rise and temperature rise. The second current enters the condenser 6 to release heat and condense. The heat source medium supplies the driving heat load through the high-temperature heat exchanger 5 and the evaporator 7, the cooling medium takes away the low-temperature heat load through the condenser 6; the expander 1 and the second expander 2 supply power to the compressor 3 and the outside. Or the expander 1 and the second expander 2 supply power to the compressor 3, the pump 4 and the outside. The combined cycle power device is formed.

Combined with FIG. 1, what needs to be declared is:

\textcircled{1} From a structural point of view, the expression “expander 1 and second expander 2 are connected compressor 3 and transmit power” mainly indicates that the power required by the compressor comes from the expansion machine of the device itself rather than the outside. The obvious connection method is that the three devices are coaxially connected together.

\textcircled{2} Generally, the output of expander 1 is greater than the power required by compressor 3. The expression that “expander 1 to connect compressor 3 and transmit power” and “expander 1 provides power to compressor 3” can be used to replace that “expander 1 and second expander 2 provide power to the outside” replaces“expander 1 and second expander 2 are connected compressor 3 and transmit power”.

\textcircled{3} For those skilled in the art, the expression “expander 1 and second expander 2 are connected compressor 3 and transmit power” is clear, and will not cause cognitive confusion.

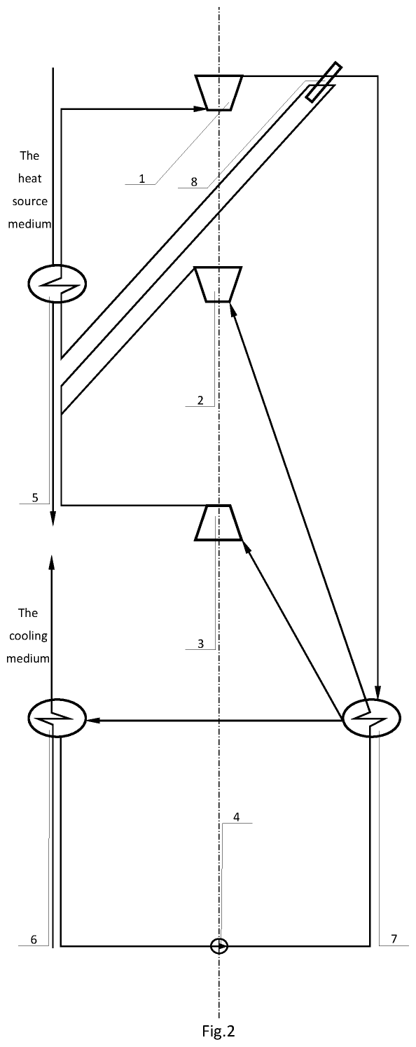

The combined cycle power device in FIG. 2 works as follows:

(1) Device structure. The combined cycle power device comprising an expander, the second expander, a compressor, a pump, a high-temperature heat exchanger, a condenser, an evaporator and a high-temperature regenerator. An evaporator 7 has a vapor channel connected the second expander 2 after that a condenser 6 has a liquid refrigerant pipe which passes through a pump 4 and connects the evaporator 7, the second expander 2 has a vapor channel which passes through the high-temperature regenerator 8 and connects the high-temperature heat exchanger 5, a compressor 3 has a vapor channel which passes through the high-temperature regenerator 8 and connects the high-temperature heat exchanger 5, the high-temperature heat exchanger 5 has a vapor channel connected an expander 1, the expander 1 has a low-pressure vapor channel connected the high-temperature regenerator 8, the evaporator 7 has a low-pressure vapor channel connected the compressor 3 and the condenser 6 respectively after that the high-temperature regenerator 8 has a low-pressure vapor channel connected the evaporator 7. The high-temperature heat exchanger 5 has the heat source medium channel connected the outside, the condenser 6 has the cooling medium channel connected the outside. The expander 1 and the second expander 2 connect the compressor 3 and transmit power.

(2) Working processes. The condensate of the condenser 6 flows through the pump 4 and enters into the evaporator 7 in which it absorbs heat, vaporizes and superheats, flows through the second expander 2 to depressurize and output work, and flows through the high-temperature regenerator 8 to heat absorption, and then enters the high-temperature heat exchanger 5 for heat absorption. The vapor discharged from compressor 3 enters the high-temperature regenerator 8 for heat absorption. The vapor discharged from the high-temperature heat exchanger 5 flows through the expander 1 to depressurize and output work. The low-pressure vapor discharged from the expander 1 flows through the evaporator 7 and the high-temperature regenerator 8 to release heat and cool down, and then is divided into two currents. The first current enters the compressor 3 for pressure rise and temperature rise. The second current enters the condenser 6 to release heat and condense. The heat source medium supplies the driving heat load through the high-temperature heat exchanger 5. The cooling medium takes away the low-temperature heat load through the condenser 6; the expander 1 and the second expander 2 supply power to the compressor 3 and the outside. Or the expander 1 and the second expander 2 supply power to the compressor 3, the pump 4 and the outside. The combined cycle power device is formed.

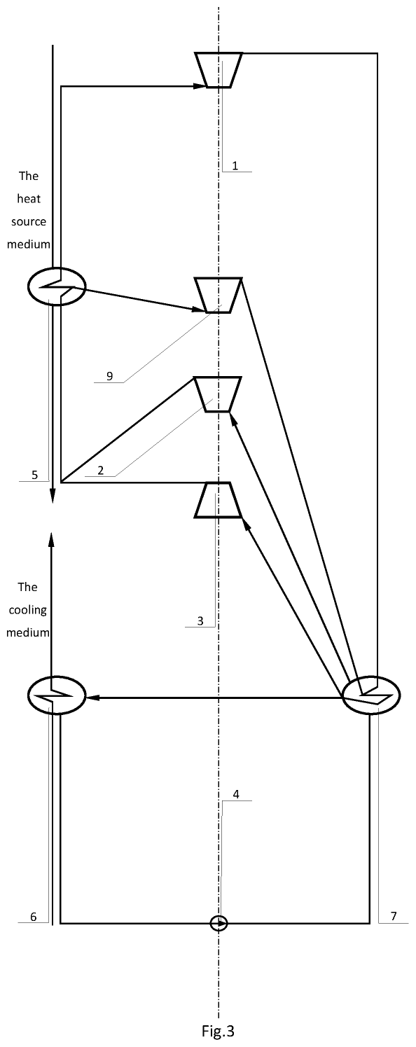

The combined cycle power device in FIG. 3 works as follows:

(1) Device structure. The combined cycle power device comprising an expander, the second expander, a compressor, a pump, a high-temperature heat exchanger, a condenser, an evaporator and the third expander. An evaporator 7 has a vapor channel connected the second expander 2 after that a condenser 6 has a liquid refrigerant pipe which passes through a pump 4 and connects the evaporator 7, the second expander 2 has a vapor channel connected the high-temperature heat exchanger 5, a compressor 3 has a vapor channel connected the high-temperature heat exchanger 5, the high-temperature heat exchanger 5 has an intermediate vapor channel connected the third expander 9, the third expander 9 has a low-pressure vapor channel which passes through intermediate vapor channel and connects the evaporator 7, the high-temperature heat exchanger 5 has a vapor channel connected an expander 1, the expander 1 has a low-pressure vapor channel connected the evaporator 7, the evaporator 7 has a low-pressure vapor channel connected the compressor 3 and the condenser 6 respectively. The high-temperature heat exchanger 5 has the heat source medium channel connected the outside, the condenser 6 has the cooling medium channel connected the outside. The expander 1, the second expander 2 and the third expander 9 connect the compressor 3 and transmit power.

(2) Working processes. The condensate of the condenser 6 flows through the pump 4 and enters into the evaporator 7 in which it absorbs heat, vaporizes and superheats, flows through the second expander 2 to depressurize and output work, and then enters the high-temperature heat exchanger 5 for heat absorption. The vapor discharged from compressor 3 enters the high-temperature heat exchanger 5 for heat absorption, the vapor enters the high-temperature heat exchanger 5 absorbs heat to a certain degree, and then is divided into two currents. The first current is supplied to the third expander 9 through the intermediate vapor passage discharged from the high-temperature heat exchanger 5 for depressurize and output work. The second current continues to heat absorption, and then enters the expander 1 for depressurize and output work. The low-pressure vapor discharged from the third expander 9 is provided to the evaporator 7 through the intermediate vapor inlet passage of the evaporator 7, the low-pressure vapor discharged from the expander 1 enters the evaporator 7 to release heat and cools to a certain extent, and then merges with the low-pressure vapor from the third expander 9, and then is divided into two currents. The first current enters the compressor 3 for pressure rise and temperature rise. The second current enters the condenser 6 to release heat and condense. The heat source medium supplies the driving heat load through the high-temperature heat exchanger 5. The cooling medium takes away the low-temperature heat load through the condenser 6. The expander 1, the second expander 2 and the third expander 9 supply power to the compressor 3 and the outside. Or the expander 1, the second expander 2 and the third expander 9 supply power to the compressor 3, the pump 4 and the outside. The combined cycle power device is formed.

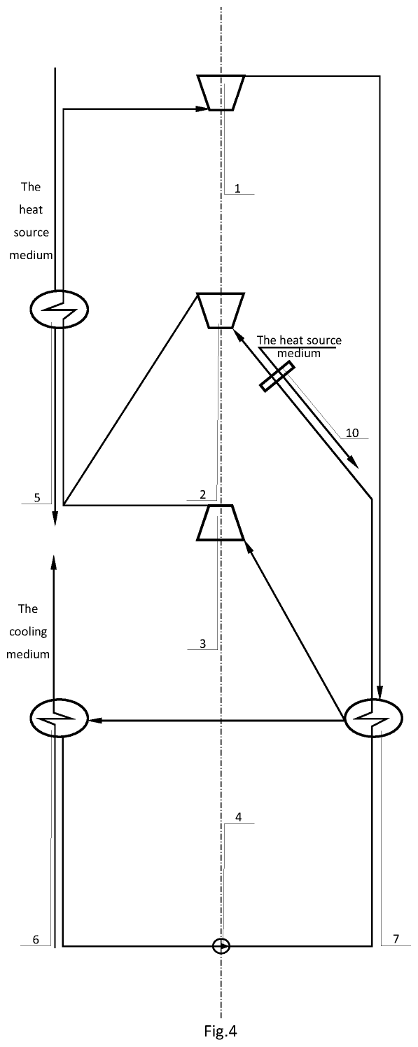

The combined cycle power device in FIG. 4 works as follows:

(1) Device structure. The combined cycle power device comprising an expander, the second expander, a compressor, a pump, a high-temperature heat exchanger, a condenser, an evaporator and the second high-temperature heat exchanger. An evaporator 7 has a vapor channel which passes though the second high-temperature heat exchanger 10 and connects the second expander 2 after that a condenser 6 has a liquid refrigerant pipe which passes through a pump 4 and connects the evaporator 7, the second expander 2 has a vapor channel connected the high-temperature heat exchanger 5, a compressor 3 has a vapor channel connected the high-temperature heat exchanger 5, the high-temperature heat exchanger 5 has a vapor channel connected an expander 1, the expander 1 has a low-pressure vapor channel connected the evaporator 7, the evaporator 7 has a low-pressure vapor channel connected the compressor 3 and the condenser 6 respectively. The high-temperature heat exchanger 5 and the second high-temperature heat exchanger 10 have the heat source medium channel connected the outside, the condenser 6 has the cooling medium channel connected the outside. The expander 1 and the second expander 2 connect the compressor 3 and transmit power.

(2) Working processes. The condensate of the condenser 6 flows through the pump 4 and enters into the evaporator 7 in which it absorbs heat, vaporizes and superheats. The superheated vapor flows through the second high-temperature heat exchanger 10 for heat absorption, flows through the second expander 2 to depressurize and output work, and then enters the high-temperature heat exchanger 5 for heat absorption. The vapor discharged from compressor 3 flows through the high-temperature heat exchanger 5 to heat absorption. The vapor discharged from the high-temperature heat exchanger 5 flows through the expander 1 to depressurize and output work. The low-pressure vapor discharged from the expander 1 flows through the evaporator 7 to release heat and cool down, and then is divided into two currents. The first current enters the compressor 3 for pressure rise and temperature rise. The second current enters the condenser 6 to release heat and condense. The heat source medium supplies the driving heat load through the high-temperature heat exchanger 5 and the second high-temperature heat exchanger 10. The cooling medium takes away the low-temperature heat load through the condenser 6. The expander 1 and the second expander 2 supply power to the compressor 3 and the outside. Or the expander 1 and the second expander 2 supply power to the compressor 3, the pump 4 and the outside. The combined cycle power device is formed.

It should be noted that in comparison, the evaporator 7 in FIG. 1 can be regarded as the result of the combination of the evaporator 7 and the second high temperature heat exchanger 10 in FIG. 4. When the temperature of the heat source medium is very different, the layout of FIG. 4 also makes sense.

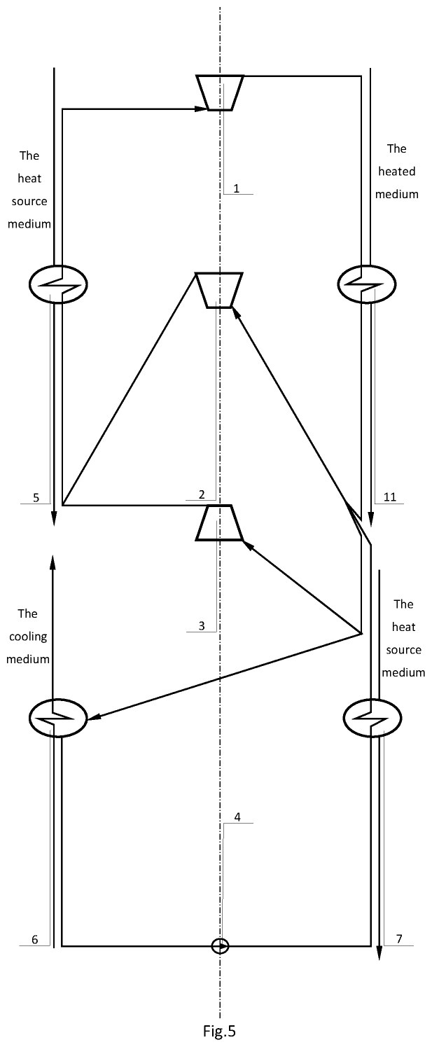

The combined cycle power device in FIG. 5 works as follows:

(1) Device structure. The combined cycle power device comprising an expander, the second expander, a compressor, a pump, a high-temperature heat exchanger, a condenser, an evaporator and a heating unit. An evaporator 7 has a vapor channel connected the second expander 2 after that a condenser 6 has a liquid refrigerant pipe which passes through a pump 4 and connects the evaporator 7, the second expander 2 has a vapor channel connected the high-temperature heat exchanger 5, a compressor 3 has a vapor channel connected the high-temperature heat exchanger 5, the high-temperature heat exchanger 5 has a vapor channel connected an expander 1, the expander 1 has a low-pressure vapor channel connected the heating unit 11, the heating unit 11 has a low-pressure vapor channel connected the compressor 3 and the condenser 6 respectively. The high-temperature heat exchanger 5 has the heat source medium channel connected the outside, the condenser 6 has the cooling medium channel connected the outside. The evaporator 7 has the heat source medium channel connected the outside, the heating unit 11 has a channel to be heated connected the outside, the expander 1 and the second expander 2 connect the compressor 3 and transmit power.

(2) Working processes. The condensate of the condenser 6 flows through the pump 4 and enters into the evaporator 7 in which it absorbs heat, vaporizes and superheats, flows through the second expander 2 to depressurize and output work, and then enters the high-temperature heat exchanger 5 for heat absorption. The vapor discharged from compressor 3 flows through the high-temperature heat exchanger 5 to heat absorption, The vapor discharged from the high-temperature heat exchanger 5 flows through the expander 1 to depressurize and output work. The low-pressure vapor discharged from the expander 1 flows through the heating unit 11 to release heat and cool down, and then is divided into two currents. The first current enters the compressor 3 for pressure rise and temperature rise. The second current enters the condenser 6 to release heat and condense. The heat source medium supplies the driving heat load through the high-temperature heat exchanger 5 and the evaporator 7. The cooling medium takes away the low-temperature heat load through the condenser 6; the expander 1 and the second expander 2 supply power to the compressor 3 and the outside. Or the expander 1 and the second expander 2 supply power to the compressor 3, the pump 4 and the outside. The combined cycle power device is formed.

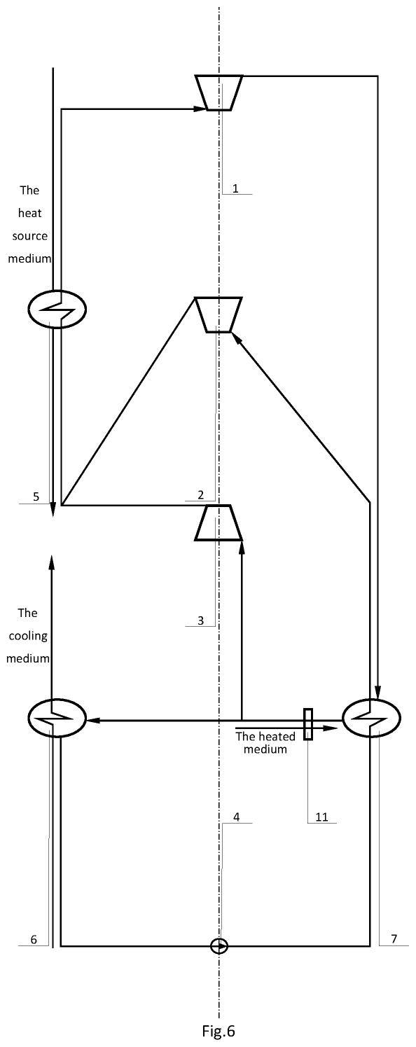

The combined cycle power device in FIG. 6 works as follows:

(1) Device structure. The combined cycle power device comprising an expander, the second expander, a compressor, a pump, a high-temperature heat exchanger, a condenser, an evaporator and a heating unit. An evaporator 7 has a vapor channel connected the second expander 2 after that a condenser 6 has a liquid refrigerant pipe which passes through a pump 4 and connects the evaporator 7, the second expander 2 has a vapor channel connected the high-temperature heat exchanger 5, a compressor 3 has a vapor channel connected the high-temperature heat exchanger 5, the high-temperature heat exchanger 5 has a vapor channel connected an expander 1, the expander 1 has a low-pressure vapor channel connected an evaporator 7, an evaporator 7 has a low-pressure vapor channel connected the heating unit 11, the heating unit 11 has a low-pressure vapor channel connected the compressor 3 and the condenser 6 respectively. The high-temperature heat exchanger 5 has the heat source medium channel connected the outside, the condenser 6 has the cooling medium channel connected the outside. The heating unit 11 has a channel to be heated connected the outside, the expander 1 and the second expander 2 connect the compressor 3 and transmit power.

(2) Working processes. The condensate of the condenser 6 flows through the pump 4 and enters the evaporator 7 in which it absorbs heat, vaporizes and superheats, flows through the second expander 2 to depressurize and output work, and then enters the high-temperature heat exchanger 5 for heat absorption. The vapor discharged from compressor 3 flows through the high-temperature heat exchanger 5 for heat absorption, and then enters the expander 1 to depressurize and output work. The low-pressure vapor discharged from the expander 1 flows through the evaporator 7 and the heating unit 11 to release heat and cool down, and then is divided into two currents. The first current enters the compressor 3 for pressure rise and temperature rise. The second current enters the condenser 6 to release heat and condense. The heat source medium supplies the driving heat load through the high-temperature heat exchanger 5. The cooling medium takes away the low-temperature heat load through the condenser 6, the heated medium takes away the medium temperature heat load through the heating unit 11. The expander 1 and the second expander 2 supply power to the compressor 3 and the outside. Or the expander 1 and the second expander 2 supply power to the compressor 3, the pump 4 and the outside. The combined cycle power device is formed.

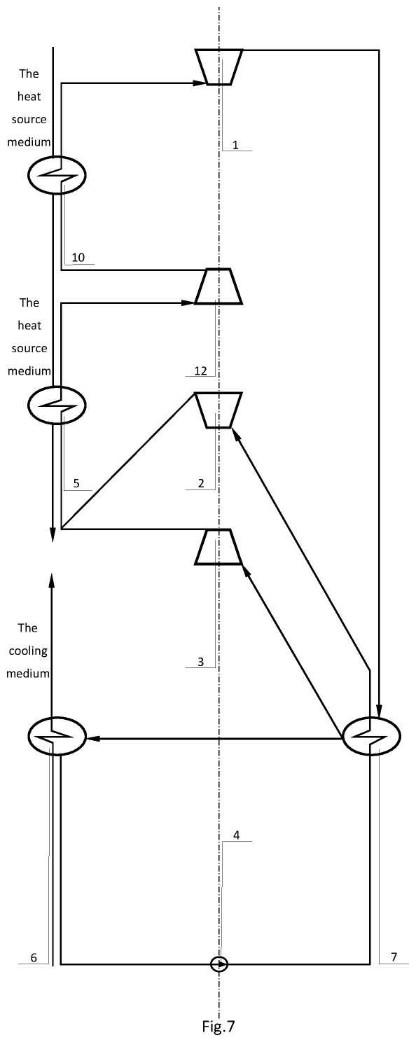

The combined cycle power device in FIG. 7 works as follows:

(1) Device structure. The combined cycle power device comprising an expander, the second expander, a compressor, a pump, a high-temperature heat exchanger, a condenser, an evaporator, the second high-temperature heat exchanger and the second compressor. An evaporator 7 has a vapor channel connected the second expander 2 after that a condenser 6 has a liquid refrigerant pipe which passes through a pump 4 and connects the evaporator 7, the second expander 2 has a vapor channel connected the high-temperature heat exchanger 5, a compressor 3 has a vapor channel connected the high-temperature heat exchanger 5, the high-temperature heat exchanger 5 has a vapor channel connected the second compressor 12, the second compressor 12 has a vapor channel which passes though the second high-temperature heat exchanger 10 and connects the expander 1, the expander 1 has a low-pressure vapor channel connected the evaporator 7, the evaporator 7 has a low-pressure vapor channel connected the compressor 3 and the condenser 6 respectively. The high-temperature heat exchanger 5 and the second high-temperature heat exchanger 10 have the heat source medium channel connected the outside, the condenser 6 has the cooling medium channel connected the outside. The expander 1 and the second expander 2 connect the compressor 3, the second compressor 12 and transmit power.

(2) Working processes. The condensate of the condenser 6 flows through the pump 4 and enters the evaporator 7 in which it absorbs heat, vaporizes and superheats, flows through the second expander 2 to depressurize and output work, and then enters the high-temperature heat exchanger 5 for heat absorption. The vapor discharged from compressor 3 flows through the high-temperature heat exchanger 5 for heat absorption; The vapor discharged from the high-temperature heat exchanger 5 flows through the second compressor 12 to pressure rise and temperature rise, flows through the second high-temperature heat exchanger 10 for heat absorption, flows through the expander 1 to depressurize and output work. The low-pressure vapor discharged from the expander 1 flows through the evaporator 7 to release heat and cool down, and then is divided into two currents. The first current enters the compressor 3 for pressure rise and temperature rise. The second current enters the condenser 6 to release heat and condense. The heat source medium supplies the driving heat load through the high-temperature heat exchanger 5 and the second high-temperature heat exchanger 10. The cooling medium takes away the low-temperature heat load through the condenser 6; the expander 1 and the second expander 2 supply power to the compressor 3, the second compressor 12 and the outside. Or the expander 1 and the second expander 2 supply power to the compressor 3, the pump 4, the second compressor 12 and the outside. The combined cycle power device is formed.

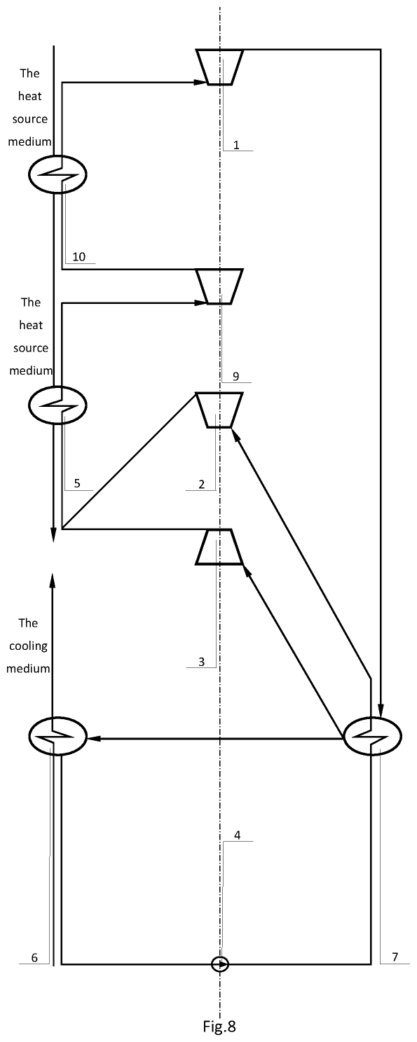

The combined cycle power device in FIG. 8 works as follows:

(1) Device structure. The combined cycle power device comprising an expander, the second expander, a compressor, a pump, a high-temperature heat exchanger, a condenser, an evaporator, the second high-temperature heat exchanger and the third expander. An evaporator 7 has a vapor channel connected the second expander 2 after that a condenser 6 has a liquid refrigerant pipe which passes through a pump 4 and connects the evaporator 7, the second expander 2 has a vapor channel connected the high-temperature heat exchanger 5, a compressor 3 has a vapor channel connected the high-temperature heat exchanger 5, the high-temperature heat exchanger 5 has an intermediate vapor channel connected the third expander 9, the third expander 9 has a low-pressure vapor channel which passes through the second high-temperature heat exchanger 10 and connects an expander 1, the expander 1 has a low-pressure vapor channel connected the evaporator 7, the evaporator 7 has a low-pressure vapor channel connected the compressor 3 and the condenser 6 respectively. The high-temperature heat exchanger 5 and the second high-temperature heat exchanger 10 have the heat source medium channel connected the outside, the condenser 6 has the cooling medium channel connected the outside. The expander 1, the second expander 2 and the third expander 9 connect the compressor 3 and transmit power.

(2) Working processes. The condensate of the condenser 6 flows through the pump 4 and enters the evaporator 7 in which it absorbs heat, vaporizes and superheats, flows through the second expander 2 to depressurize and output work, and then enters the high-temperature heat exchanger 5 for heat absorption. The vapor discharged from the compressor 3 flows through the high-temperature heat exchanger 5 for heat absorption, the vapor discharged from the high-temperature heat exchanger 5 enters the third expander 9 for depressurize and output work, flows through the second high-temperature heat exchanger 10 to heat absorption, flows through expander 1 to depressurize and output work; The low-pressure vapor discharged from the expander 1 enters the evaporator 7 to release heat and cool down, and then is divided into two currents. The first current enters the compressor 3 for pressure rise and temperature rise. The second current enters the condenser 6 to release heat and condense. The heat source medium supplies the driving heat load through the high-temperature heat exchanger 5 and the second high-temperature heat exchanger 10. The cooling medium takes away the low-temperature heat load through the condenser 6. The expander 1, the second expander 2 and the third expander 9 supply power to the compressor 3 and the outside. Or the expander 1, the second expander 2 and the third expander 9 supply power to the compressor 3, the pump 4 and the outside. The combined cycle power device is formed.

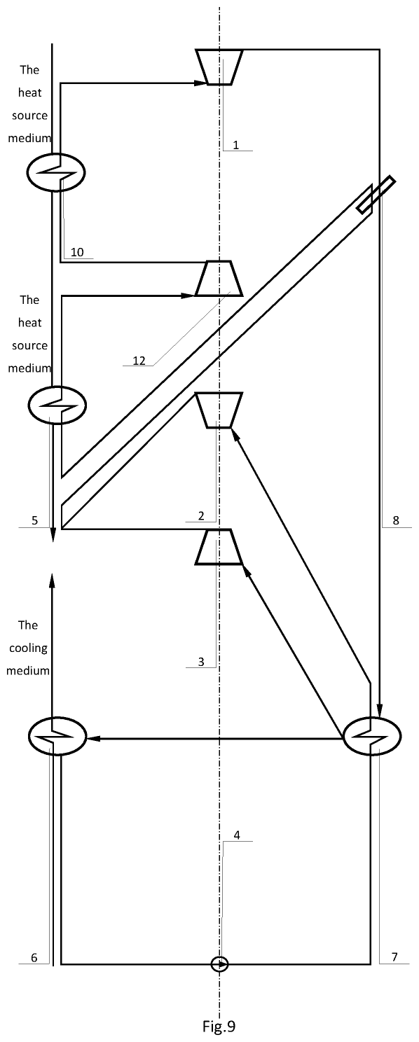

The combined cycle power device in FIG. 9 works as follows:

(1) Device structure. The combined cycle power device comprising an expander, the second expander, a compressor, a pump, a high-temperature heat exchanger, a condenser, an evaporator, a high-temperature regenerator, the second high-temperature heat exchanger and the second compressor. An evaporator 7 has a vapor channel connected the second expander 2 after that a condenser 6 has a liquid refrigerant pipe which passes through a pump 4 and connects the evaporator 7, the second expander 2 has a vapor channel which passes through the high-temperature regenerator 8 and connects the high-temperature heat exchanger 5, a compressor 3 has a vapor channel which passes through the high-temperature regenerator 8 and connects the high-temperature heat exchanger 5, the high-temperature heat exchanger 5 has a vapor channel connected the second compressor 12, the second compressor 12 has a vapor channel which passes though the second high-temperature heat exchanger 10 and connects the expander 1, the expander 1 has a low-pressure vapor channel connected the high-temperature regenerator 8, the high-temperature regenerator 8 has a low-pressure vapor channel connected the evaporator 7, the evaporator 7 has a low-pressure vapor channel connected the compressor 3 and the condenser 6 respectively. The high-temperature heat exchanger 5 and the second high-temperature heat exchanger 10 have the heat source medium channel connected the outside, the condenser 6 has the cooling medium channel connected the outside. The expander 1 and the second expander 2 connect the compressor 3, the second compressor 12 and transmit power.

(2) Working processes. The condensate of the condenser 6 flows through the pump 4 and enters the evaporator 7 in which it absorbs heat, vaporizes and superheats, flows through the second expander 2 to depressurize and output work, and flows through the high-temperature regenerator 8 to heat absorption, and then enters the high-temperature heat exchanger 5 for heat absorption. The vapor discharged from compressor 3 enters the high-temperature regenerator 8 for heat absorption, and then enters the high-temperature heat exchanger 5 for heat absorption. The vapor discharged from the high-temperature heat exchanger 5 flows through the second compressor 12 to pressure rise and temperature rise, and flows through the second high-temperature heat exchanger 10 to heat absorption, and flows through the expander 1 to depressurize and output work; The low-pressure vapor discharged from the expander 1 flows through the evaporator 7 and the high-temperature regenerator 8 to release heat and cool down, and then is divided into two currents. The first current enters the compressor 3 for pressure rise and temperature rise. The second current enters the condenser 6 to release heat and condense. The heat source medium supplies the driving heat load through the high-temperature heat exchanger 5 and the second high-temperature heat exchanger 10. The cooling medium takes away the low-temperature heat load through the condenser 6; The expander 1 and the second expander 2 supply power to the compressor 3, the second compressor 12 and the outside. Or the expander 1 and the second expander 2 supply power to the compressor 3, the pump 4, the second compressor 12 and the outside. The combined cycle power device is formed.

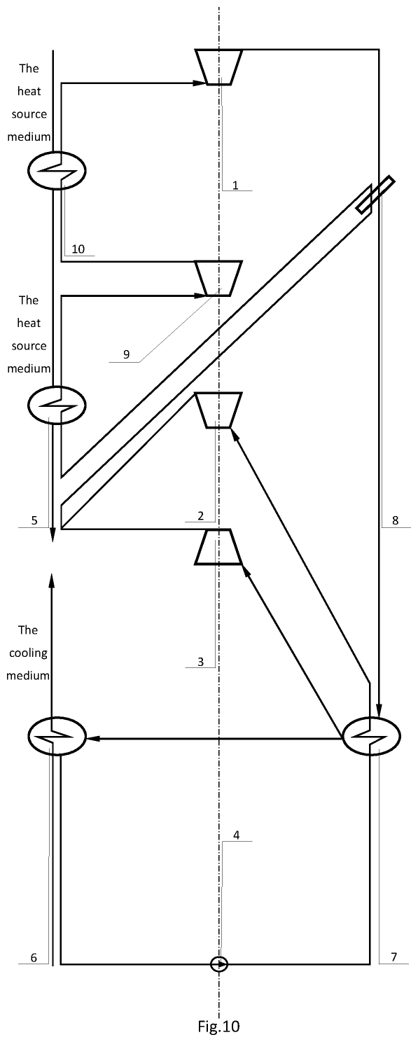

The combined cycle power device in FIG. 10 works as follows:

(1) Device structure. The combined cycle power device comprising an expander, the second expander, a compressor, a pump, a high-temperature heat exchanger, a condenser, an evaporator, a high-temperature regenerator, the third expander and the second high-temperature heat exchanger. An evaporator 7 has a vapor channel connected the second expander 2 after that a condenser 6 has a liquid refrigerant pipe which passes through a pump 4 and connects the evaporator 7, the second expander 2 has a vapor channel which passes through the high-temperature regenerator 8 and connects the high-temperature heat exchanger 5, a compressor 3 has a vapor channel which passes through the high-temperature regenerator 8 and connects the high-temperature heat exchanger 5, the high-temperature heat exchanger 5 has a vapor channel connected the third expander 9, the third expander 9 has a vapor channel which passes though the second high-temperature heat exchanger 10 and connects the expander 1, the expander 1 has a low-pressure vapor channel connected the high-temperature regenerator 8, the high-temperature regenerator 8 has a low-pressure vapor channel connected the evaporator 7, the evaporator 7 has a low-pressure vapor channel connected the compressor 3 and the condenser 6 respectively. The high-temperature heat exchanger 5 and the second high-temperature heat exchanger 10 have the heat source medium channel connected the outside, the condenser 6 has the cooling medium channel connected the outside. The second expander 2 and the third expander 9 connect the compressor 3 and transmit power.

(2) Working processes. The condensate of the condenser 6 flows through the pump 4 and enters the evaporator 7 in which it absorbs heat, vaporizes and superheats, flows through the second expander 2 to depressurize and output work, and flows through the high-temperature regenerator 8 to heat absorption, and then enters the high-temperature heat exchanger 5 for heat absorption; The vapor discharged from compressor 3 the high-temperature regenerator 8 for heat absorption, and then enters the high-temperature heat exchanger 5 for heat absorption. The vapor discharged from the high-temperature heat exchanger 5 flows through the third expander 9 to depressurize and output work, and flows through the second high-temperature heat exchanger 10 to heat absorption, and flows through the expander 1 to depressurize and output work. The low-pressure vapor discharged from the expander 1 flows through the high-temperature regenerator 8 and the evaporator 7 to release heat and cool down, and then is divided into two currents. The first current enters the compressor 3 for pressure rise and temperature rise. The second current enters the condenser 6 to release heat and condense. The heat source medium supplies the driving heat load through the high-temperature heat exchanger 5 and the second high-temperature heat exchanger 10. The cooling medium takes away the low-temperature heat load through the condenser 6. The expander 1, the second expander 2 and the third expander 9 supply power to the compressor 3 and the outside. Or the expander 1, the second expander 2 and the third expander 9 supply power to the compressor 3, the pump 4 and the outside. The combined cycle power device is formed.

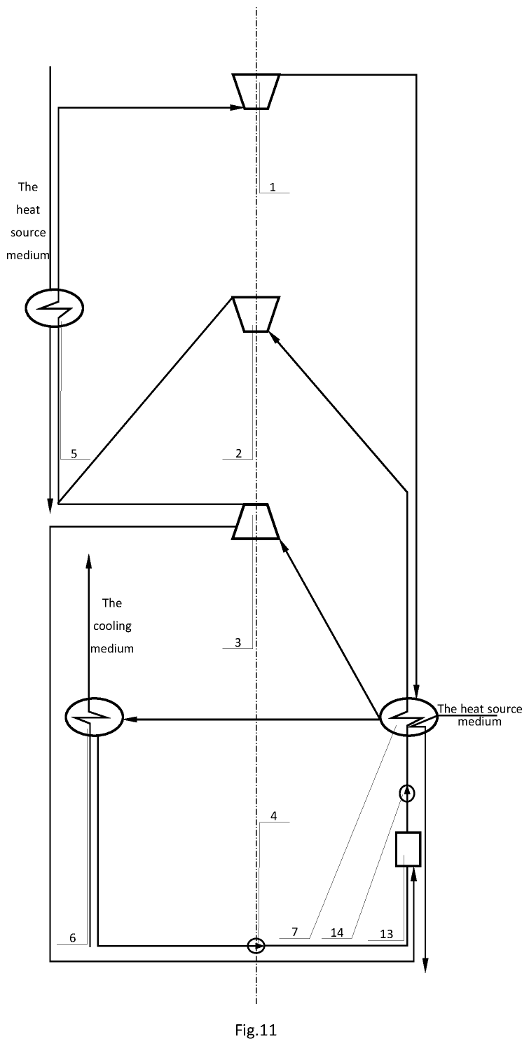

The combined cycle power device in FIG. 11 works as follows:

(1) Device structure. based on combined cycle power device in FIG. 1, a low-temperature regenerator and the second pump is added. That a condenser 6 has a liquid refrigerant pipe which passes through a pump 4 and connects with the evaporator 7 is adjusted for that a condenser 6 has a liquid refrigerant pipe which passes through a pump 4 and connects with a low-temperature regenerator 13. The compressor 3 adds a vapor extraction channel connected with the low-temperature regenerator 13. The low-temperature regenerator 13 has a liquid refrigerant pipe which passes through the second pump 14 and connects with the evaporator 7.

(2) Working processes. The condensate of the condenser 6 flows through the pump 4 and enters into the low-temperature regenerator 13, mixed with the extraction vapor discharged from compressor 3 to heat absorption, after the extraction steam and the condensate are mixed, they release heat and condense. The condensate of the low-temperature regenerator 13 flows through the second pump 14 and enters into the evaporator 7 in which it absorbs heat, vaporizes and superheats, flows through the second expander 2 to depressurize and output work, and then enters the high-temperature heat exchanger 5 for heat absorption. The vapor discharged from compressor 3 enters the high-temperature heat exchanger 5 for heat absorption. The vapor discharged from the high-temperature heat exchanger 5 flows through the expander 1 to depressurize and output work. The low-pressure vapor discharged from the expander 1 flows through the condenser 7 to release heat and cool down, and then is divided into two currents. The first current enters the compressor 3, the second current enters the condenser 6 to release heat and condense. The low-pressure vapor discharged from the compressor 3 is increased to pressure rise and temperature rise and then divided into two currents. The first current enters the low-temperature regenerator 13 through the middle vapor channel all the way release heat and condense, the second current continues to pressure rise and temperature rise. The heat source medium supplies the driving heat load through the high-temperature heat exchanger 5 and the evaporator 7. The cooling medium takes away the low-temperature heat load through the condenser 6. The expander 1 and the second expander 2 supply power to the compressor 3 and the outside. Or the expander 1 and the second expander 2 supply power to the compressor 3, the pump 4, the second pump 14 and the outside. The combined cycle power device is formed.

The technical effects of the present invention: the combined cycle power device proposed by the present invention has the following effects and advantages:

(1) The circulating working medium absorbs heat at high-temperature heat under low pressure. The temperature difference loss between the circulating working medium and the high-temperature heat source is small, which is conducive to improving the thermal efficiency of the system and the safety of the device.

(2) The circulating working medium mainly relies on the condensation phase transformation process to realize low-temperature heat release. The temperature difference loss between the circulating working medium and the environment is controllable, which is conducive to improving the thermal efficiency.

(3) The present invention adopts the low-pressure and high-temperature operation mode to work in the high-temperature region. Therefore, the contradiction among thermal efficiency, the working medium's parameters and the material's temperature resistance and pressure resistance abilities, which is common in traditional vapor power devices, can be resolved. The temperature difference loss between the heat source and the circulating medium can be greatly reduced, and the thermal efficiency can be greatly improved.

(4) In the present invention, the equipment is shared to increase the heat absorption process of the lower cycle (Rankine cycle) and improve the thermal efficiency.

(5) The present invention only uses a single working medium, which reduce the operation cost and improve the flexibility of thermal device.

(6) When the high-temperature expander is shared, the number of core equipment is reduced, which is conducive to reducing system investment and improving thermal efficiency.

(7) The present invention effectively deals with the high-temperature heat source and the variable temperature heat source, the high-quality fuel and the non high-quality fuel, and has a wide range of application.

(8) On the premise of realizing high thermal efficiency, the device in the present invention can be selected to operate at low pressure, so as to greatly improve the operation safety of the device.

(9) The present invention can realize the heat recovery of enterprise device simply, actively, safely and efficiently.

(10) The thermal efficiency improves effectively when the present invention is applied to the lower end of the gas-steam combined cycle.

(11) When the present invention is applied to the coal-fired thermal system, it can maintain the original advantages of the traditional steam power cycle in which water vapor is used as working medium and has a wide range of working parameters. According to the actual situation, the present invention can work in subcritical, critical, supercritical or ultra supercritical state, etc.

What is claimed is:

1. A combined cycle power device comprising an expander, the second expander, a compressor, a pump, a high-temperature heat exchanger, a condenser and an evaporator; wherein an evaporator (7) has a vapor channel connected the second expander (2) after that a condenser (6) has a liquid refrigerant pipe which passes through a pump (4) and connects the evaporator (7), the second expander (2) has a vapor channel connected the high-temperature heat exchanger (5), a compressor (3) has a vapor channel connected the high-temperature heat exchanger (5), the high-temperature heat exchanger (5) has a vapor channel connected an expander (1), the evaporator (7) has a low-pressure vapor channel connected the compressor (3) and the condenser (6) respectively after that the expander (1) has a low-pressure vapor channel connected the evaporator (7), wherein the high-temperature heat exchanger (5) has the heat source medium channel connected the outside, the condenser (6) has the cooling medium channel connected the outside, or the evaporator (7) has the heat source medium channel connected the outside, the expander (1) and the second expander (2) connect the compressor (3) and transmit power, wherein or the expander (1) and the second expander (2) connect the compressor (3) and the pump (4) and transmit power.

2. A combined cycle power device comprising an expander, the second expander, a compressor, a pump, a high-temperature heat exchanger, a condenser, an evaporator and a high-temperature regenerator; wherein an evaporator (7) has a vapor channel connected the second expander (2) after that a condenser (6) has a liquid refrigerant pipe which passes through a pump (4) and connects the evaporator (7), the second expander (2) has a vapor channel which passes through a high-temperature regenerator (8) and connects a high-temperature heat exchanger (5), a compressor (3) has a vapor channel which passes through the high-temperature regenerator (8) and connects the high-temperature heat exchanger (5), the high-temperature heat exchanger (5) has a vapor channel connected an expander (1), the expander (1) has a low-pressure vapor channel connected the high-temperature regenerator (8), the evaporator (7) has a low-pressure vapor channel connected the compressor (3) and the condenser (6) respectively after that the high-temperature regenerator (8) has a low-pressure vapor channel connected the evaporator (7), wherein the high-temperature heat exchanger (5) has the heat source medium channel connected the outside, the condenser (6) has the cooling medium channel connected the outside, or the evaporator (7) has the heat source medium channel connected the outside, the expander (1) and the second expander (2) connect the compressor (3) and transmit power, wherein or the expander (1) and the second expander (2) connect the compressor (3) and the pump (4) and transmit power.

3. A combined cycle power device comprising an expander, the second expander, a compressor, a pump, a high-temperature heat exchanger, a condenser, an evaporator and the third expander; wherein an evaporator (7) has a vapor channel connected the second expander (2) after that a condenser (6) has a liquid refrigerant pipe which passes through a pump (4) and connects the evaporator (7), the second expander (2) has a vapor channel connected a high-temperature heat exchanger (5), a compressor (3) has a vapor channel connected the high-temperature heat exchanger (5), the high-temperature heat exchanger (5) has an intermediate vapor channel connected the third expander (9), the third expander (9) has a low-pressure vapor channel which passes through intermediate vapor channel and connects the evaporator (7), the high-temperature heat exchanger (5) has a vapor channel connected an expander (1), the expander (1) has a low-pressure vapor channel connected the evaporator (7), the evaporator (7) has a low-pressure vapor channel connected the compressor (3) and the condenser (6) respectively, wherein the high-temperature heat exchanger (5) has the heat source medium channel connected the outside, the condenser (6) has the cooling medium channel connected the outside, or the evaporator (7) has the heat source medium channel connected the outside, the expander (1), the second expander (2) and the third expander (9) connect the compressor (3) and transmit power, wherein or the expander (1), the second expander (2) and the third expander (9) connect the compressor (3) and the pump (4) and transmit power.

4. A combined cycle power device comprising an expander, the second expander, a compressor, a pump, a high-temperature heat exchanger, a condenser, an evaporator and the second high-temperature heat exchanger; wherein an evaporator (7) has a vapor channel which passes though the second high-temperature heat exchanger (10) and connects the second expander (2) after that a condenser (6) has a liquid refrigerant pipe which passes through a pump (4) and connects the evaporator (7), the second expander (2) has a vapor channel connected the high-temperature heat exchanger (5), a compressor (3) has a vapor channel connected the high-temperature heat exchanger (5), the high-temperature heat exchanger (5) has a vapor channel connected an expander (1), the expander (1) has a low-pressure vapor channel connected the evaporator (7), the evaporator (7) has a low-pressure vapor channel connected the compressor (3) and the condenser (6) respectively, wherein the high-temperature heat exchanger (5) and the second high-temperature heat exchanger (10) have the heat source medium channel connected the outside, the condenser (6) has the cooling medium channel connected the outside, or the evaporator (7) has the heat source medium channel connected the outside, the expander (1) and the second expander (2) connect the compressor (3) and transmit power, wherein or the expander (1) and the second expander (2) connect the compressor (3) and the pump (4) and transmit power.

5. A combined cycle power device comprising an expander, the second expander, a compressor, a pump, a high-temperature heat exchanger, a condenser, an evaporator and a heating unit; wherein an evaporator (7) has a vapor channel connected the second expander (2) after that a condenser (6) has a liquid refrigerant pipe which passes through a pump (4) and connects the evaporator (7), the second expander (2) has a vapor channel connected the high-temperature heat exchanger (5), a compressor (3) has a vapor channel connected the high-temperature heat exchanger (5), the high-temperature heat exchanger (5) has a vapor channel connected an expander (1), the expander (1) has a low-pressure vapor channel connected the heating unit (11), the heating unit (11) has a low-pressure vapor channel connected the compressor (3) and the condenser (6) respectively, wherein the high-temperature heat exchanger (5) has the heat source medium channel connected the outside, the condenser (6) has the cooling medium channel connected the outside, or the evaporator (7) has the heat source medium channel connected the outside, the heating unit (11) has a channel to be heated connected the outside, the expander (1) and the second expander (2) connect the compressor (3) and transmit power, wherein or the expander (1) and the second expander (2) connect the compressor (3) and the pump (4) and transmit power.

6. A combined cycle power device comprising an expander, the second expander, a compressor, a pump, a high-temperature heat exchanger, a condenser, an evaporator and a heating unit; wherein an evaporator (7) has a vapor channel connected the second expander (2) after that a condenser (6) has a liquid refrigerant pipe which passes through a pump (4) and connects the evaporator (7), the second expander (2) has a vapor channel connected the high-temperature heat exchanger (5), a compressor (3) has a vapor channel connected the high-temperature heat exchanger (5), the high-temperature heat exchanger (5) has a vapor channel connected an expander (1), the expander (1) has a low-pressure vapor channel connected an evaporator (7), an evaporator (7) has a low-pressure vapor channel connected the heating unit (11), the heating unit (11) has a low-pressure vapor channel connected the compressor (3) and the condenser (6) respectively, wherein the high-temperature heat exchanger (5) has the heat source medium channel connected the outside, the condenser (6) has the cooling medium channel connected the outside, or the evaporator (7) has the heat source medium channel connected the outside, the heating unit (11) has a channel to be heated connected the outside, the expander (1) and the second expander (2) connect the compressor (3) and transmit power, wherein or the expander (1) and the second expander (2) connect the compressor (3) and the pump (4) and transmit power.

7. A combined cycle power device comprising an expander, the second expander, a compressor, a pump, a high-temperature heat exchanger, a condenser, an evaporator, the second high-temperature heat exchanger and the second compressor; wherein an evaporator (7) has a vapor channel connected the second expander (2) after that a condenser (6) has a liquid refrigerant pipe which passes through a pump (4) and connects the evaporator (7), the second expander (2) has a vapor channel connected a high-temperature heat exchanger (5), a compressor (3) has a vapor channel connected the high-temperature heat exchanger (5), the high-temperature heat exchanger (5) has a vapor channel connected the second compressor (12), the second compressor (12) has a vapor channel which passes though the second high-temperature heat exchanger (10) and connects an expander (1), the expander (1) has a low-pressure vapor channel connected the evaporator (7), the evaporator (7) has a low-pressure vapor channel connected the compressor (3) and the condenser (6) respectively, wherein the high-temperature heat exchanger (5) and the second high-temperature heat exchanger (10) have the heat source medium channel connected the outside, the condenser (6) has the cooling medium channel connected the outside, or the evaporator (7) has the heat source medium channel connected the outside, the expander (1) and the second expander (2) connect the compressor (3), the second compressor (12) and transmit power, wherein or the expander (1) and the second expander (2) connect the compressor (3), the pump (4), the second compressor (12) and transmit power.

8. A combined cycle power device comprising an expander, the second expander, a compressor, a pump, a high-temperature heat exchanger, a condenser, an evaporator, the second high-temperature heat exchanger and the third expander; wherein an evaporator (7) has a vapor channel connected the second expander (2) after that a condenser (6) has a liquid refrigerant pipe which passes through a pump (4) and connects the evaporator (7), the second expander (2) has a vapor channel connected the high-temperature heat exchanger (5), a compressor (3) has a vapor channel connected the high-temperature heat exchanger (5), the high-temperature heat exchanger (5) has an intermediate vapor channel connected the third expander (9), the third expander (9) has a low-pressure vapor channel which passes through the second high-temperature heat exchanger (10) and connects an expander (1), the expander (1) has a low-pressure vapor channel connected the evaporator (7), the evaporator (7) has a low-pressure vapor channel connected the compressor (3) and the condenser (6) respectively, wherein the high-temperature heat exchanger (5) and the second high-temperature heat exchanger (10) have the heat source medium channel connected the outside, the condenser (6) has the cooling medium channel connected the outside, or the evaporator (7) has the heat source medium channel connected the outside, the expander (1), the second expander (2) and the third expander (9) connect the compressor (3) and transmit power, wherein or the expander (1), the second expander (2) and the third expander (9) connect the compressor (3) and the pump (4) and transmit power.

9. A combined cycle power device comprising an expander, the second expander, a compressor, a pump, a high-temperature heat exchanger, a condenser, an evaporator, a high-temperature regenerator, the second high-temperature heat exchanger and the second compressor; wherein an evaporator (7) has a vapor channel connected the second expander (2) after that a condenser (6) has a liquid refrigerant pipe which passes through a pump (4) and connects the evaporator (7), the second expander (2) has a vapor channel which passes through a high-temperature regenerator (8) and connects a high-temperature heat exchanger (5), a compressor (3) has a vapor channel which passes through the high-temperature regenerator (8) and connects the high-temperature heat exchanger (5), the high-temperature heat exchanger (5) has a vapor channel connected the second compressor (12), the second compressor (12) has a vapor channel which passes though the second high-temperature heat exchanger (10) and connects an expander (1), the expander (1) has a low-pressure vapor channel connected the high-temperature regenerator (8), the high-temperature regenerator (8) has a low-pressure vapor channel connected the evaporator (7), the evaporator (7) has a low-pressure vapor channel connected the compressor (3) and the condenser (6) respectively, wherein the high-temperature heat exchanger (5) and the second high-temperature heat exchanger (10) have the heat source medium channel connected the outside, the condenser (6) has the cooling medium channel connected the outside, or the evaporator (7) has the heat source medium channel connected the outside, the expander (1) and the second expander (2) connect the compressor (3), the second compressor (12) and transmit power, wherein or the expander (1) and the second expander (2) connect the compressor (3), the pump (4), the second compressor (12) and transmit power.

10. A combined cycle power device comprising an expander, the second expander, a compressor, a pump, a high-temperature heat exchanger, a condenser, an evaporator, a high-temperature regenerator, the third expander and the second high-temperature heat exchanger; wherein an evaporator (7) has a vapor channel connected the second expander (2) after that a condenser (6) has a liquid refrigerant pipe which passes through a pump (4) and connects the evaporator (7), the second expander (2) has a vapor channel which passes through the high-temperature regenerator (8) and connects the high-temperature heat exchanger (5), a compressor (3) has a vapor channel which passes through the high-temperature regenerator (8) and connects the high-temperature heat exchanger (5), the high-temperature heat exchanger (5) has a vapor channel connected the third expander (9), the third expander (9) has a vapor channel which passes though the second high-temperature heat exchanger (10) and connects the expander (1), the expander (1) has a low-pressure vapor channel connected the high-temperature regenerator (8), the high-temperature regenerator (8) has a low-pressure vapor channel connected the evaporator (7), the evaporator (7) has a low-pressure vapor channel connected the compressor (3) and the condenser (6) respectively, wherein the high-temperature heat exchanger (5) and the second high-temperature heat exchanger (10) have the heat source medium channel connected the outside, the condenser (6) has the cooling medium channel connected the outside, or the evaporator (7) has the heat source medium channel connected the outside, the expander (1), the second expander (2) and the third expander (9) connect the compressor (3) and transmit power, wherein or the expander 1, the second expander (2) and the third expander (9) connect the compressor (3) and the pump (4) and transmit power.

11. The device according to any one of claim 1-10, wherein adding a low-temperature regenerator and the second pump, adjusting that the condenser (6) has a liquid refrigerant pipe which passes through a pump (4) and connects the evaporator (7) to that the condenser (6) has a liquid refrigerant pipe which passes through a pump (4) and connects a low-temperature regenerator (13), the compressor (3) adds the vapor extraction channel connected the low-temperature regenerator (13), the low-temperature regenerator (13) has a liquid refrigerant pipe which passes through the second pump (14) and connects the evaporator (7), a combined cycle power device is formed.
